(19) United States
(12) Patent Application Publication
(10) Pub. No.: US 2009/0320323 A1
(43) Pub. Date: Dec. 31, 2009

(54) DEVICE WITH A DRUM AND FLEXIBLE BELTS

(75) Inventor: Jean-Michel Dubus, Nantes en Rattier (FR)

Correspondence Address: PEARNE & GORDON LLP, 1801 EAST 9TH STREET, SUITE 1200, CLEVELAND, OH, 44114-3108, US

(73) Assignee: RIETER PERFOJET, Montbonnot, FR (FR)

(21) Appl. No.: 12/306,737

(22) PCT Filed: Jun. 28, 2007
(86) PCT No.: PCT/FR07/01090

§ 371 Date: Dec. 29, 2008

(30) Foreign Application Priority Data
Jul. 11, 2006 (FR) 06 06284
Sep. 7, 2006 (FR) 06 07831

(51) Int. Cl. D21F 5/02; F26B 13/10

(52) U.S. Cl. 34/601; 34/122; 34/124; 34/126; 34/131; 34/602; 34/605

(57) ABSTRACT

This device comprises a drum having a lateral surface through which fluid can pass, and two flexible belts (2) which pass over the lateral surface of the drum (1) at a distance from one another, each of them on an idle guide roller (3) of its own. Each roller (3) is mounted so as to pivot about a vertical axis (7).

The present invention refers to devices with a drum and flexible belts. The invention relates to a device which makes it possible to adjust the effective width of a cylinder having a permeable surface. It relates, in particular, to the field involving the drying of nonwovens (or textile or paper) by means of a dryer which is referred to as a “through-air dryer” with air being blown through the product to be dried. But said invention can also refer to the field of filtration or any other field in which the aim is to cause a fluid to pass through the surface of a cylinder.

In the case of a through-air dryer, the product is generally wrapped around one or more permeable drums. Hot air is blown through a hood which is disposed around the drum or drums. An area of low pressure is produced inside the drum or drums in order to suck in this air, which thus passes through the product. As it passes through the product, the air exchanges energy and gives rise to evaporation of the water. The water vapour is then carried along with the flow of air. Some of the air is then evacuated to the outside, but the major portion is reheated and re-circulated.

In this technology it is important, for satisfactory efficiency of the dryer, that the permeable width of the drum should correspond to the width of the web to be dried.

In actual fact, if the product is wider than the permeable zone of the drum, the flow of air will not pass through the ends of the product to be dried, and they will consequently not be dried satisfactorily.

If, on the other hand, the product is narrower than the permeable zone of the oven, the flow of air will tend to pass in greater measure through the zones which are not covered by the product. This results in a general reduction in the efficiency of the dryer and in heterogeneous drying of the web; those edges of the web which are situated close to the leakage zones remain wetter than the parts which are further away from the leaks.

In order to avoid this phenomenon, it is therefore desirable to have available a system that makes it possible to adjust the width of aspiration of the drum to the width of the product to be dried. The principle is to occlude the two ends of the permeable zone of the drum by suitable means.

Systems of this kind exist (belts fixed around the drum, devices having adjustable baffles which are situated inside the drum). These systems are effective but suffer from the drawbacks of either having to stop the machine in order to carry out adjustment (in the case of the fixed belts) or of being relatively costly.

A device exists which has two flexible belts which are disposed around the drum on the outside and are each tightened by a return roller. The return roller is mounted on a carriage which slides vertically in order to tighten the belt (the weight of the carriage is adapted to the necessary tension). The belt is guided by using a return roller having a cambered or double cone-shaped profile. Adjusting the position of the two belts defines the aspiration width of the drum.

However, this device has limitations.

There is a very large difference in diameter between the main drum of the dryer (generally between 1 m and 3 m in diameter) and the return roller (generally 100 to 200 mm in diameter). Moreover, the free strands of the belt (those elements of length over which the belt is not in contact either with the main drum or with the return roller) are very short.

The consequence of this configuration is as follows:

A slight defect in the geometry of the main drum or of the belt or a very slight defect in parallelism between the main drum and the return roller sets up, at each revolution, a major deviation in the belt which naturally tends to follow the trajectory imposed by the drum.

The short length of the slack strands of the belt between the main drum and the return roller does not allow the belt to compensate for this deviation by mere deformation, nor does it allow the cambered or double cone-shaped profile of the return roller to keep the belt in the central part of said return roller.

Because of this, the belt tends to become displaced towards one or other edge of the return roller, until it bears against the fixed parts of the device. There ensues damage to the belt which reduces its life span and a risk of pollution of the nonwoven by foreign particles originating from the belt.

When the operator tries to correct this displacement by modifying the adjustment of the guide carriage, he generally manages to obtain an adjustment which induces the belt to become displaced in the other direction. But the point of equilibrium at which the belt is perfectly centred is extremely sensitive and practically impossible to obtain.

An additional constraint is the operating temperature of the device, which gives rise to deformation of the elements and modifies the geometry of the whole unit. Thus, an adjustment which provides correct behaviour at a certain temperature will no longer be stable when the temperature changes as a result of different production conditions.

Finally, it should be noted that adjusting the position of the two belts on the drum, which should make it possible to precisely define the width of aspiration, is impossible at production speed. This adjustment requires that the drum revolve at a low speed which enables the operators to work in complete safety.

This results in a loss of productivity in the line and in an additional difficulty since the width of the nonwoven on the main drum is also sensitive to the production speed of the line, and a working width which is optimised at low speed will no longer be optimised at normal production speed.

The invention overcomes these drawbacks.

The subject of the invention is a device comprising:
a drum having an axis of rotation and a lateral surface through which fluid can pass; and
two flexible belts which pass over the lateral surface of the drum at a distance from one another, each of them on an idle guide roller of its own.

A drum of this kind is disclosed by DE 44 36 745 A1.

The invention is characterised in that each roller is mounted so as to pivot about an axis which is perpendicular to the axis of rotation of the roller and which is located in the median plane perpendicular to the axis of the roller.

When the axis of rotation of the drum is horizontal and when the guide rollers, too, have horizontal axes of rotation and are located below the drum, each roller is mounted so as to pivot about an axis which is vertical or is inclined to the vertical by less than 30° in the upstream direction in relation to the direction of running of the belt. The vertical axis of pivoting of the roller is preferably offset on the upstream side, in relation to the direction of running of the belt, from the axis of rotation of the roller by less than 15°.

The invention imparts to the return roller a degree of orientation which enables it to compensate, on the one hand, for defects in alignment between the components and, on the other hand, for defects in geometry of said components (roller, drum or belt). The geometry of the device defined by the invention also enables the orientation of the roller to be brought about by the belt itself when the latter deviates from its ideal central position, without the aid of an external device. Thus, once the position of the guide carriage has been defined, the system no longer requires external intervention and maintains perfect guidance of the belt, even if the conditions change because of the temperature or other external parameters.

Each roller is preferably mounted so as to slide parallel to the axis of the drum and is mounted so as to also slide vertically. A convenient method of realising the invention consists in mounting each roller on a carriage that adjusts its position. Each roller can be mounted so as to revolve about its axis within a cradle connected to the carriage which is equipped with two lateral pulleys which are mounted so as to revolve about an axis perpendicular to the belt, said pulleys being disposed on either side of the roller.

A device which, although particularly simple, makes it possible to combine in one and the same function the movements of vertical sliding and of orientation within the horizontal plane of each roller, is one in which each roller can be mounted so as to revolve about its axis within a cradle fixed rigidly to a cylindrical axle which is guided by cylindrical rings.

The axis of pivoting of the roller may pass through the middle of the axis of rotation of the roller, but is preferably shifted on the upstream side, in relation to the direction of running of the belt, from the axis of rotation of the roller.

The invention also relates to a dryer comprising a blowing hood and a device according to the invention which is disposed within said hood. Means are provided for causing a web which is to be dried, or some other product in sheet form which is to be dried, to pass onto the drum between the two belts.

In the drawings, which are given solely by way of an example:

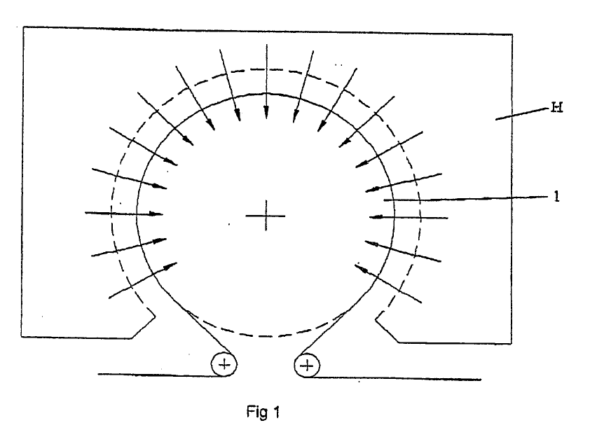

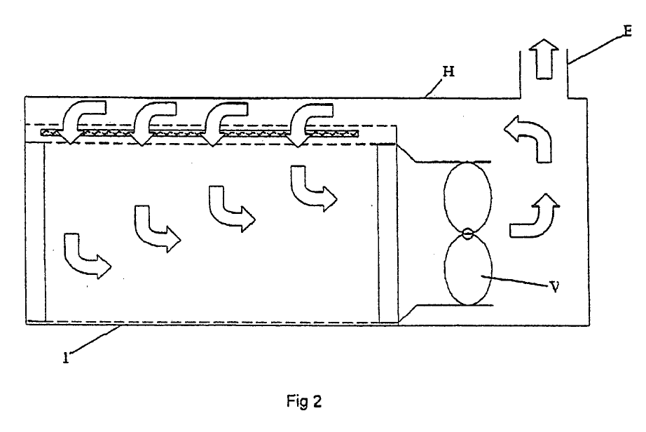

FIG. 1 is a diagrammatic profile view of a through-air oven;

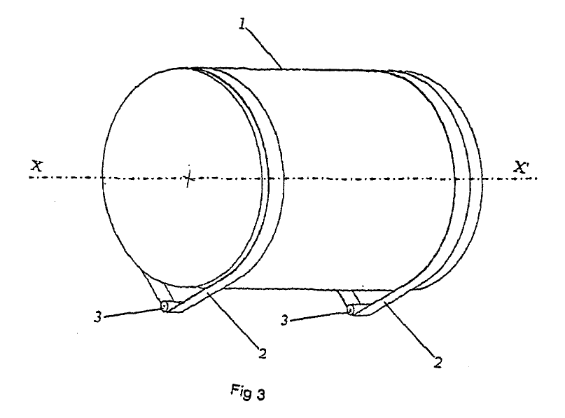

FIG. 2 is a diagrammatic view in section of the through-air oven in FIG. 1;

FIG. 3 is a view in perspective of a drum and two rollers over which belts according to the invention pass;

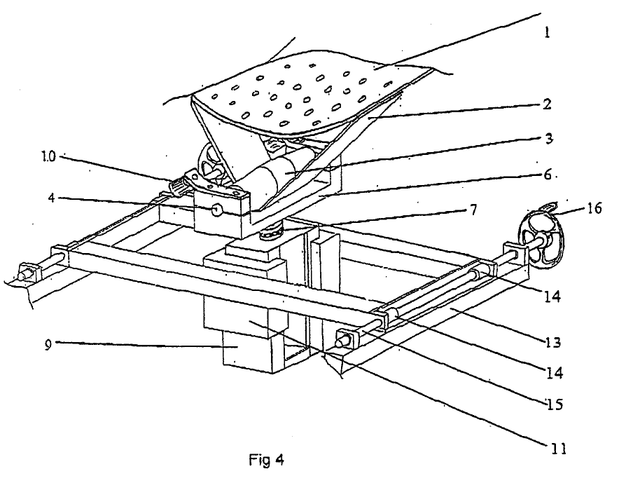

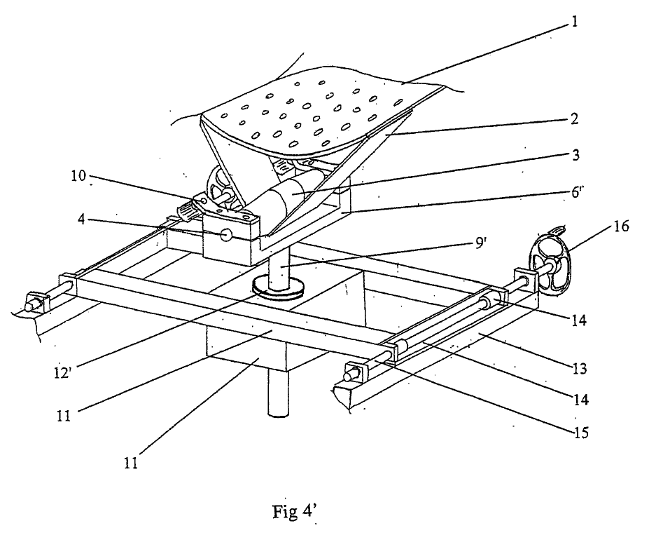

FIG. 4 is a partial view in perspective of the device according to the invention;

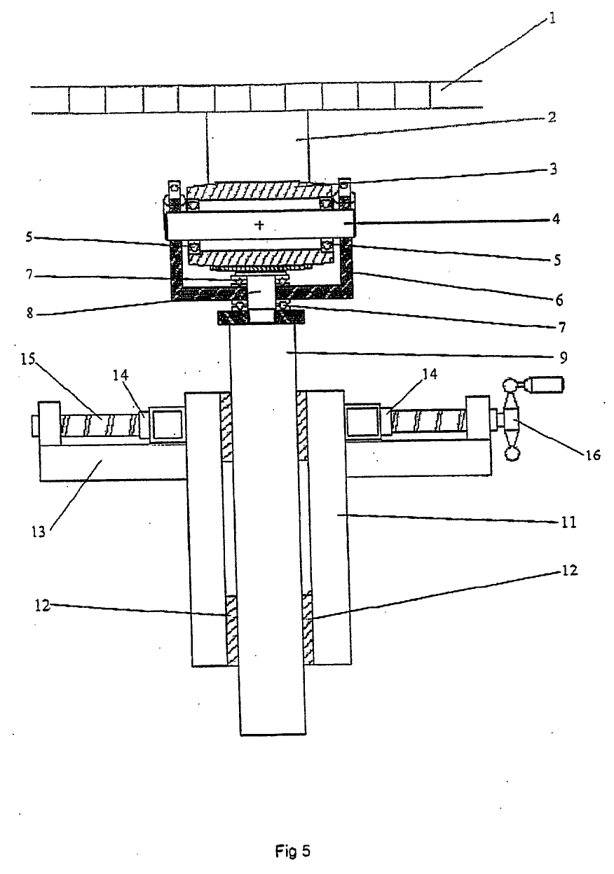

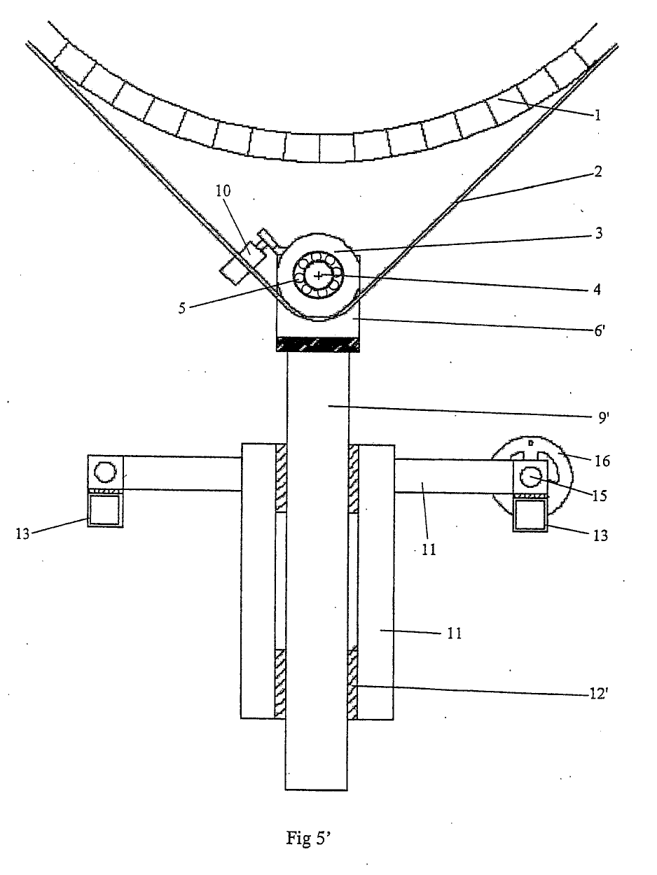

FIG. 5 is a partial view in section, parallel to the axis of the drum, of the device according to the invention;

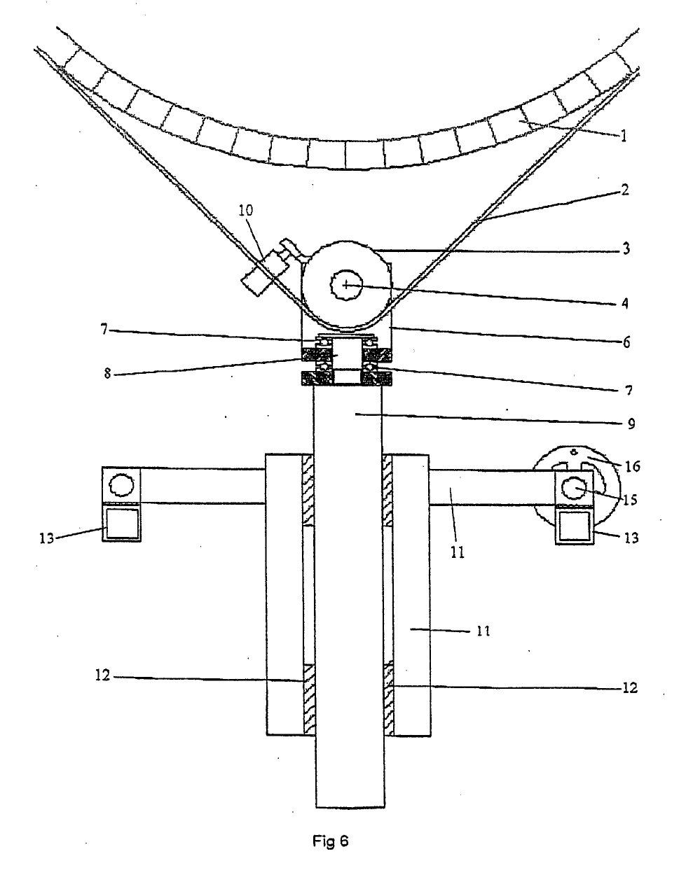

FIG. 6 is a partial view in section, perpendicularly to the axis of the drum, of the device according to the invention;

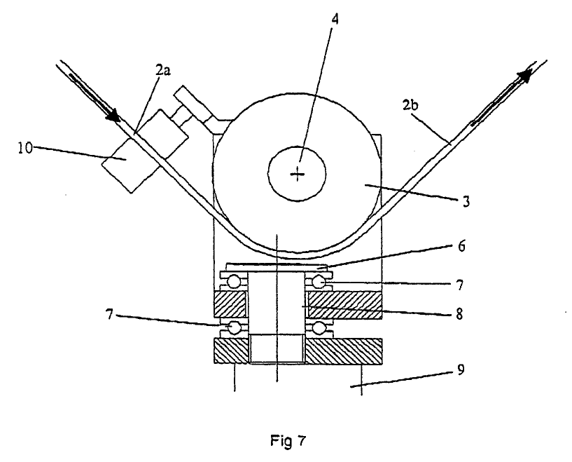

FIG. 7 is a diagrammatic view illustrating a variant;

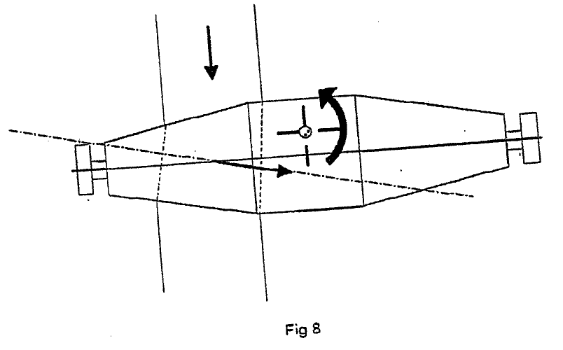

FIG. 8 is an explanatory diagrammatic view corresponding to the variant in FIG. 7;

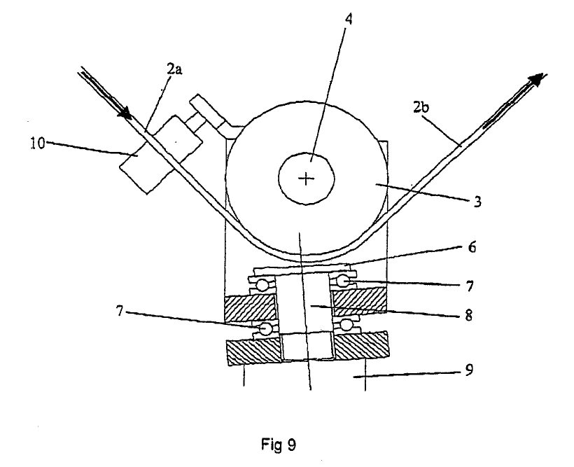

FIG. 9 is a diagrammatic view illustrating another variant;

FIG. 4′ is a partial view in perspective of a variant of the device according to the invention; and

FIG. 5′ is a partial view in section, perpendicularly to the axis of the drum, of a variant of the device according to the invention.

The through-air oven represented in FIGS. 1 and 2 comprises a blowing hood H surrounding a drum 1 whose lateral surface is perforated. Hot air is blown from the hood to the interior of the drum, where an area of low pressure is provided. Some of the air is evacuated to the outside via a fan V and an exhaust E, while another portion is reheated and sent back into the hood H. The arrows in FIGS. 1 and 2 illustrate the passage of the air.

As FIG. 3 shows, the drum has a horizontal axis of rotation x-x′ and a perforated lateral surface through which fluid is therefore able to pass. Two belts 2 pass over the lateral surface of the drum 1 at a distance from one another. Each one passes over an idly mounted guide roller 3. The roller is preferably of the type with a cambered or double cone-shaped profile. Adjusting the position of the two belts 2 defines the aspiration width of the drum 1.

As FIGS. 4 to 6 show, the device according to the invention comprises:
a drum 1 having a permeable surface and a diameter which is generally between 1.0 and 3.0 m, although the invention may also be suitable for diameters which are smaller or larger than these values;
a set of, generally two, flexible belts 2 which are disposed around the drum. These belts bear against the surface of the drum in order to occlude the permeable surface of the latter over a zone which is defined by the width of the belt and the angle of winding of the belt around the drum. By adjusting the distance between the two belts, it is thus possible to modify the width of aspiration of the drum.

Associated with each belt is a tightening and guiding device comprising:
a return roller 3 with a cylindrical, cambered or double cone-shaped profile. This roller is mounted on a cylindrical axle 4 via two bearings 5 which make it possible to ensure free rotation of the roller. The roller is positioned inside the loop constituted by the belt, in order to tighten the latter.

The whole unit is mounted in a cradle 6 which is connected to a carriage 9. The link between the cradle and the carriage is brought about via an axle 8 and two ball bearings or thrust-bearings 7 which permit free rotation of the cradle about a vertical axis while at the same time blocking the other degrees of freedom between the said two elements.

The cradle is also equipped with two lateral pulleys 10 whose axis of rotation is perpendicular to the belt. These pulleys serve as a stop for the belt when the latter tends to become displaced laterally on the return roller.

A chassis 11 equipped with vertical slides 12 receives the carriage 7 and enables the latter to slide in a vertical direction. This vertical movement, which is caused by the weight of the carriage, makes it possible to impart the necessary tension to the belt.

The chassis 11 is mounted on a fixed framework 13 via a guide unit which permits displacement of the chassis in a horizontal direction parallel to the axis of rotation of the permeable drum. The guide unit may be made up of a set of rings 14 sliding on a fixed shaft. A device made up of an endless screw 15 makes it possible to activate the movement, either by means of a manually controlled hand-wheel 16 or by means of a remotely-driven electric motor. Other guiding and motorising devices which make it possible to bring about this translational movement may also be used.

As FIGS. 4′ and 5′ show, a preferred variant of the device according to the invention comprises:
a drum 1 having a permeable surface and a diameter which is generally between 1.0 and 3.0 m, although the invention may also be suitable for diameters which are smaller or larger than these values;
a set of, generally two, flexible belts 2 which are disposed around the drum. These belts bear against the surface of the drum in order to occlude the permeable surface of the latter over a zone which is defined by the width of the belt and the angle of winding of the belt around the drum. By adjusting the distance between the two belts, it is thus possible to modify the width of induction of the drum.

Associated with each belt is a tightening and guiding device comprising a return roller 3 with a cylindrical, cambered or double cone-shaped profile. This roller is mounted on a cylindrical axle 4 via two bearings 5 which make it possible to ensure free rotation of the roller. The roller is positioned inside the loop constituted by the belt, in order to tighten the latter.

The whole unit is mounted in a cradle 6′ which is fixed rigidly to a cylindrical axle 9′ guided by cylindrical rings 12′. It is thus possible to combine, in one and the same function, the movements of vertical sliding and of orientation within the horizontal plane of the roller 3.

A chassis 11 equipped with the cylindrical rings 12′ receives the axle 9′ and enables it to slide in a vertical direction. This vertical movement, which is caused by the weight of the carriage, makes it possible to impart the necessary tension to the belt.

The chassis 11 is mounted on a fixed framework 13 via a guide unit which permits displacement of the chassis in a horizontal direction parallel to the axis of rotation of the permeable drum. The guide unit may be made up of a set of rings 14 sliding on a fixed shaft. A device made up of an endless screw 15 makes it possible to activate the movement, either by means of a manually controlled hand-wheel 16 or by means of a remotely-driven electric motor. Other guiding and motorising devices which make it possible to bring about this translational movement may also be used.

Two principles come into play in the operation of the invention, and both of them are linked to the behaviour of a belt when it is wound onto a rotating drum.

The first principle is linked to the fact that the adhesion of the belt to the drum compels the belt to follow, in the course of its contact around the drum, the trajectory of the point of contact.

Thus, if the belt comes into contact with a cylinder which is not perfectly perpendicular to the direction of arrival of the belt, the latter will follow, throughout the period of contact with the drum, a different direction which is perpendicular to the axis of rotation of the drum. When it leaves the drum again, it has therefore undergone a lateral displacement which is pronounced to a greater or lesser extent, depending upon the angle of deviation and the length of the contact between the belt and the cylinder.

The second principle that comes into play in the operation of the invention is the behaviour of a belt when it is wound flat onto a non-cylindrical surface, for example a cone.

In this case, a belt which arrives perpendicularly to the axis of the cone will, in order to be wound flat onto the surface of the cone, follow a helical trajectory and thus be displaced towards the large diameter of the cone.

Finally, in order to understand the invention, it is expedient to concern oneself with the forces which are applied to the belt by the return roller and therefore, as a result of reaction of the belt, to the return roller.

The belt 2, which is wound around the return roller 3, constitutes a sort of V, the two walls of which are constituted by the strands of the belt. These two strands undergo a tightening force T which is proportional to the weight P suspended under the return roller. The consequence is that, throughout the contact zone of the belt on the return roller, the belt exerts, on said return roller, a pressure pr which is applied perpendicularly to the surface of the return roller. The total force applied by the belt to the return roller is obtained by adding together all the pressing forces applied to each element of the contact surface.

This force is directed along the bisector of the angle set up by the two strands of the belt and is directed perpendicularly to the surface of the return roller.

This force may be broken down into a force Fv which is parallel to the direction of the axis of rotation of the pivot 8, and a force Fh which is perpendicular to the direction of the axis of rotation of said pivot 8.

Thus, this force may set up, depending upon the relative position of the two strands of the belt and the position and angle of the axis of the pivot, a rotational torque which tends to modify the orientation of the roller around the axis of the pivot.

This orientation will tend to displace the belt laterally.

By choosing the geometry of the device judiciously, it is thus possible to obtain perfect guidance of the belt, both with a cylindrical return roller and with a return roller which is double cone-shaped or has a cambered profile.

As a last resort, if the forces engendered by the belt are too low to bring about a rotation of the return roller which is sufficient to bring the belt back towards the centre of said return roller, said belt will bear against the lateral pulleys. This bearing force will set up a rotational torque that is added to the rotational torque described above, and augment the orientation of the return roller.

In the variant represented in FIG. 7, the axis of pivoting of the roller has been displaced towards the belt 2a on the upstream side in the direction of running of the belt, the belt on the downstream side bearing the reference numeral 2b. The torque that brings the belt at 2 into position is thus augmented, and the device reacts in a more stable and effective manner.

The same applies in the variant represented in FIG. 9, in which the axis of tilting 7 forms an angle of 7° with the vertical, being inclined, from bottom to top, in the direction of the upstream strand 2a of the belt.

1. Device comprising:
a drum having an axis of rotation and a lateral surface through which fluid can pass; and
two flexible belts which pass over the lateral surface of the drum at a distance from one another, each of them on an idle guide roller of its own,
characterised in that each roller is mounted so as to pivot about an axis which is perpendicular to the axis of rotation of the roller and which is located in the median plane perpendicular to the axis of the roller.

2. Device according to claim 1, characterised in that the axis of rotation of the drum is horizontal and the rollers are below the drum, the axis of tilting of the roller being vertical or being inclined to the vertical by less than 30° in the upstream direction in relation to the direction of running of the belt.

3. Device according to claim 1, characterised in that each roller is mounted so as to slide parallel to the axis of the drum.

4. Device according to claim 1, characterised in that each roller is mounted so as to slide vertically.

5. Device according to claim 1, characterised in that each roller is mounted on a carriage that adjusts its position.

6. Device according to claim 1, characterised in that each roller is mounted so as to revolve about its axis within a cradle connected to a carriage which is equipped with two lateral pulleys which are mounted so as to revolve about an axis perpendicular to the belt, said pulley being disposed on either side of the roller.

7. Device according to claim 1, characterised in that the axis of pivoting of the roller passes through the middle of the axis of rotation of the roller.

8. Device according to claim 1, characterised in that the vertical axis of pivoting of the roller is offset on the upstream side, in relation to the direction of displacement of the belt, from the axis of rotation of the roller.

9. Device according to claim 1, characterised in that each roller is mounted so as to pivot about an axis which is inclined to the vertical by less than 30° in the upstream direction in relation to the direction of running of the belt.

10. Device according to claim 1, characterised in that each roller is mounted so as to pivot about an axis which is perpendicular to the axis of rotation of the roller and which is located in the median plane perpendicular to the axis of the roller,
each roller being mounted so as to revolve about its axis within a cradle fixed rigidly to a cylindrical axle which is guided by cylindrical rings.

11. Dryer comprising a blowing hood, characterised in that a device according to claim 1 is disposed within the hood, and means are provided for causing a web which is to be dried to pass onto the drum between the two belts.
